(19) United States
(12) Patent Application Publication
(10) Pub. No.: US 2018/0208047 A1
(43) Pub. Date: Jul. 26, 2018

(54) CONTROL DEVICE

(71) Applicant: AISIN AW CO., LTD., Anjo-shi, Aichi-ken (JP)

(72) Inventors: Shoichi ISHIDA, Toyoake (JP); Kohei TSUDA, Nishio (JP); Norihiro MUTO, Anjo (JP)

(73) Assignee: AISIN AW CO., LTD., Anjo-shi, Aichi-ken (JP)

(21) Appl. No.: 15/744,570

(22) PCT Filed: Sep. 8, 2016
(86) PCT No.: PCT/JP2016/076516

§ 371 Date: Jan. 12, 2018

(30) Foreign Application Priority Data
Sep. 18, 2015 (JP) 2015-185512

(51) Int. Cl. B60K 6/547; B60W 10/06; B60W 10/10; B60W 20/30; F02D 29/06; B60K 6/48; B60W 10/02

(52) U.S. Cl. CPC B60K 6/547; B60W 10/06; B60W 10/10; B60W 10/02; F02D 29/06; B60K 6/48; B60W 20/30

(57) ABSTRACT

A control device that controls a vehicle drive transmission device including a speed change device disposed on a power transmission path connecting an internal combustion engine and wheels, and an engagement device disposed between the internal combustion engine and the speed change device, the control device including an electronic control unit.

### BACKGROUND

The present disclosure relates to a control device that controls a vehicle drive transmission device.

There has been used a vehicle drive transmission device that includes an engagement device and a speed change device on a power transmission path connecting an internal combustion engine and wheels. This type of vehicle drive transmission device is disclosed, for example, in Japanese Patent Application Publication No. 9-331602 (JP 9-331602 A). In the vehicle drive transmission device of JP 9-331602 A, the state of engagement of an engagement device disposed between an internal combustion engine and a speed change device is set to either an engaged state or a disengaged state in accordance with the drive mode. In other words, when implementing a drive mode in which the engagement device is in the engaged state to drive the vehicle using the internal combustion engine as a driving force source, the engagement device is maintained in the engaged state.

In the case where, for example, a shift operation is performed while the engagement device is maintained in the engaged state, as the speed ratio is changed during the shift operation, at least the rotational speed of the internal combustion engine is changed by the shift operation. Therefore, the operational status of the internal combustion engine is changed by the shift operation, which may reduce the traveling performance of the vehicle in some cases. For example, if the rotational speed of the internal combustion engine falls into a rotational speed range that is too low to maintain self-sustaining combustion operation, and the internal combustion engine stalls, stable vehicle travel may be impaired. However, JP 9-331602 A does not take this issue into consideration.

### SUMMARY

An exemplary aspect of the present disclosure provides a technique that makes it possible to maintain stable vehicle travel even when the operational status of an internal combustion engine is changed by a shift operation.

A control device according to the present disclosure controls a vehicle drive transmission device including a speed change device disposed on a power transmission path connecting an internal combustion engine and wheels, and an engagement device disposed between the internal combustion engine and the speed change device, the control device includes an electronic control unit that is configured to execute in-shift slip control to cause the engagement device to slip during a shift operation such that a rotational speed of the internal combustion engine is maintained at an idle rotational speed or higher, when a shift request for changing a speed ratio of the speed change device is received while the internal combustion engine is operating with self-sustaining combustion, if the rotational speed of the internal combustion engine becomes less than the idle rotational speed during the shift operation that is performed in response to the shift request, wherein the rotational speed of the internal combustion engine is determined in accordance with a rotational speed of the wheels that is obtained when the engagement device is in a direct-coupling engaged state.

With this configuration, in the case where the rotational speed of the internal combustion engine becomes less than the idle rotational speed during the shift operation if the engagement device is in a direct-coupling engaged state, in-shift slip control is executed. By executing such in-shift slip control, it is possible to maintain the rotational speed of the internal combustion engine at the idle rotational speed or higher while transferring the output torque of the internal combustion engine to the transmission side. Thus, it is possible to appropriately drive the vehicle using the output torque of the internal combustion engine, and to prevent the internal combustion engine from stalling. Accordingly, it is possible to make the internal combustion engine operate stably, and to maintain stable vehicle travel.

Further features and advantages of the technique of the present disclosure will become more readily apparent from the following description of illustrative, non-limiting embodiments when taken in conjunction with the accompanying drawings.

### BRIEF DESCRIPTION OF THE DRAWINGS

FIG. 1 is a schematic view illustrating a vehicle drive transmission device according to an embodiment.

FIG. 2 is a block diagram illustrating the schematic configuration of a control device.

FIG. 3 illustrates an example of the relationship between an operating point of an internal combustion engine and an inappropriate operating area.

FIG. 4 is a flowchart illustrating the procedure of shift control including in-shift slip control.

FIG. 5 is a timing chart illustrating an example of in-shift slip control according to a first aspect.

FIG. 6 is a timing chart illustrating an example of in-shift slip control according to a second aspect.

FIG. 7 is a schematic view illustrating a vehicle drive transmission device according to another embodiment.

FIG. 8 is a schematic view illustrating a vehicle drive transmission device according to another embodiment.

### DETAILED DESCRIPTION OF EMBODIMENTS

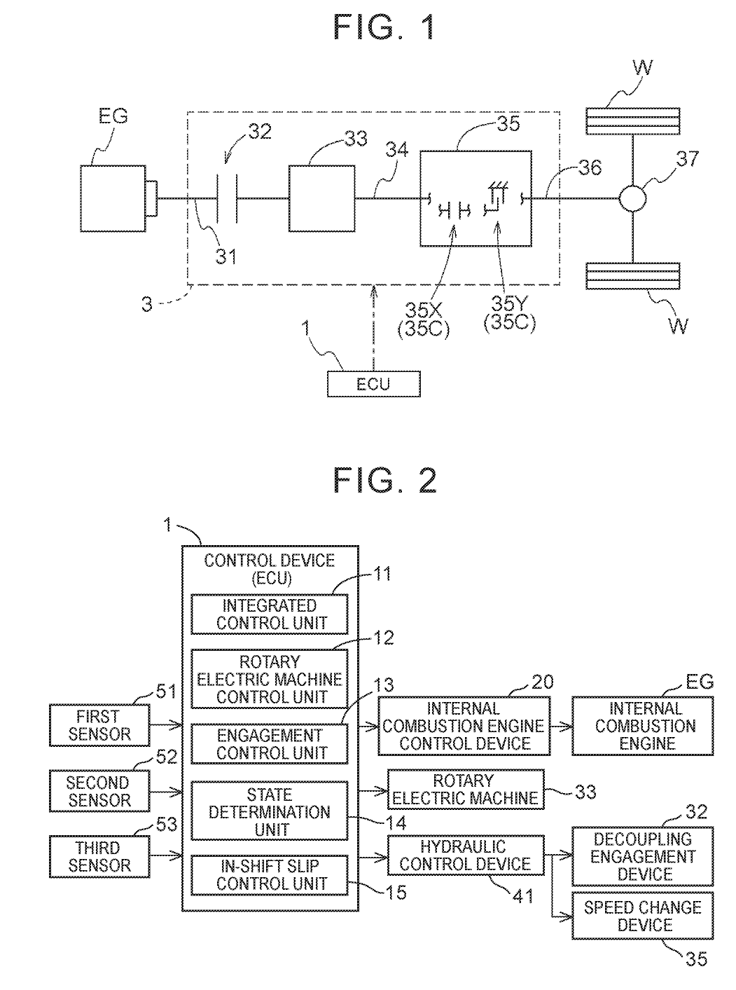

An embodiment of a control device will be described. A control device 1 is a control device for a vehicle drive transmission device, and controls a vehicle drive transmission device 3. In the present embodiment, the vehicle drive transmission device 3 is a drive transmission device (hybrid vehicle drive transmission device) for driving a vehicle (hybrid vehicle) that includes both an internal combustion engine EG and a rotary electric machine 33 as driving force sources for wheels W. The vehicle drive transmission device 3 is configured as a parallel hybrid vehicle drive transmission device for driving a parallel type hybrid vehicle. Note that in FIG. 1, the control device 1 is represented as “ECU”.

In the following description, the term “drivingly coupled” refers to a state in which two rotary elements are coupled to allow transmission of a driving force (that is, torque). This state includes a state in which the two rotary elements are coupled to rotate together, and a state in which the two rotary elements are coupled via one or more transmission members to allow transmission of a driving force. Examples of such transmission members include various types of members that transmit rotation at the same speed or a changed speed (such as a shaft, a gear mechanism, and a belt), and may include engagement devices that selectively transmit rotation and a driving force (such as a friction engagement device and a meshing-type engagement device).

Furthermore, the term “rotary electric machine” refers to any of a motor (electric motor), a generator (electric generator), and a motor generator that serves as both a motor and a generator as necessary.

As for the state of engagement of a friction engagement device, an “engaged state” indicates a state in which a transfer torque capacity is produced in the friction engagement device. The transfer torque capacity refers to the maximum torque that can be transferred by friction of a friction engagement device. The magnitude of the transfer torque capacity is proportional to the pressure (engagement pressure) at which paired engagement members (an input-side engagement member and an output-side engagement member) included in the friction engagement device are pushed against each other. The “engaged state” includes a “direct-coupling engaged state” in which there is no difference in rotational speed (slip) between the paired engagement members, and a “slip engaged state” in which there is a difference in rotational speed. The “disengaged state” indicates a state in which no transfer torque capacity is produced in the friction engagement device.

As illustrated in FIG. 1, the vehicle drive transmission device 3 includes a decoupling engagement device 32, a rotary electric machine 33, and a speed change device 35, on a power transmission path connecting the internal combustion engine EG and the wheels W. In order to transmit rotation and a driving force between the components on the power transmission path, the vehicle drive transmission device 3 further includes an input member 31, a shift input member 34, and an output member 36. In the present embodiment, the input member 31, the decoupling engagement device 32, the rotary electric machine 33, the shift input member 34, the speed change device 35, and the output member 36 are disposed on the power transmission path in this order from the internal combustion engine EG side. Note that the vehicle drive transmission device 3 is a drive transmission device of a type without a hydraulic coupling, in which a hydraulic coupling (such as a torque converter and a fluid coupling) is not provided between the internal combustion engine EG and the speed change device 35. Since the vehicle drive transmission device 3 of the present embodiment is not provided with a hydraulic coupling, it is not possible to transmit the driving force of the internal combustion engine EG toward the wheels W via a hydraulic coupling. Accordingly, in order to transmit the driving force of the internal combustion engine EG toward the wheels W, the decoupling engagement device 32 needs to be brought into the direct-coupling engaged state or the slip engaged state.

The input member 31 is drivingly coupled to the internal combustion engine EG. The internal combustion engine EG is a motor (such as a gasoline engine and a diesel engine) that is driven by combustion of fuel inside the engine so as to output power. The input member 31 includes, for example, a shaft member (input shaft). The input member 31 is drivingly coupled to an internal combustion engine output member (such as a crank shaft) serving as an output member of the internal combustion engine EG to rotate therewith. Accordingly, the rotational speed of the input member 31 matches a rotational speed Neg of the internal combustion engine EG. Note that the input member 31 and the internal combustion engine output member may be directly coupled, or may be coupled via another member such as a damper. The input member 31 is drivingly coupled to the rotary electric machine 33 via the decoupling engagement device 32.

The decoupling engagement device 32 is disposed between the input member 31 and the speed change device 35, and selectively couples the input member 31 and the speed change device 35. In the present embodiment, the decoupling engagement device 32 is disposed between the input member 31 and the rotary electric machine 33, and selectively couples the input member 31 and the rotary electric machine 33. In other words, the decoupling engagement device 32 is capable of decoupling the internal combustion engine EG from the rotary electric machine 33 and the speed change device 35. The decoupling engagement device 32 serves as an internal combustion engine decoupling engagement device that decouples the internal combustion engine EG from the wheels W. In the present embodiment, the decoupling engagement device 32 is a friction engagement device, which may be, for example, a wet multi-plate clutch. In the present embodiment, the decoupling engagement device 32 corresponds to an “engagement device”.

The rotary electric machine 33 includes a stator fixed to a case, which is a non-rotary member, and a rotor rotatably supported on the radially inner side of the stator. The rotary electric machine 33 is connected to an electricity storage device via an inverter device. The rotary electric machine 33 is supplied with electricity from the electricity storage device to perform power running, or supplies electricity that is generated using torque of the internal combustion engine EG, an inertial force of the vehicle, or the like to the electricity storage device to store the electricity therein. The rotor of the rotary electric machine 33 is coupled to the shift input member 34 to rotate therewith. Accordingly, a rotational speed Nin of the shift input member 34 matches the rotational speed of the rotary electric machine 33 (rotor). The shift input member 34 includes, for example, a shaft member (shift input shaft). The shift input member 34 that rotates with the rotor is drivingly coupled to the speed change device 35.

In the present embodiment, the speed change device 35 is configured as a stepped automatic speed change device. The speed change device 35 of the present embodiment includes, for example, a planetary gear mechanism (not illustrated) and a plurality of shift engagement devices 35C. The shift engagement devices 35C include one or more clutches 35X and one or more brakes 35Y. In the present embodiment, the clutch 35X and the brake 35Y included in the shift engagement devices 35C are friction engagement devices. For example, the clutch 35X and the brake 35Y may be a wet multi-plate clutch and a wet multi-plate brake, respectively. Note that the shift engagement devices 35C may include one or more one-way clutches.

The speed change device 35 can selectively establish one of a plurality of shift speeds, in accordance with the state of engagement of each shift engagement device 35C. For example, the speed change device 35 selectively brings two of the plurality of shift engagement devices 35C into the direct-coupling engaged state, thereby establishing a shift speed corresponding to the combination of the engaged shift engagement devices 35C. The speed change device 35 changes the rotational speed Nin of the shift input member 34 based on a speed ratio corresponding to the established shift speed, and then transmits the changed rotational speed Nin to the output member 36. Note that a “speed ratio” refers to a ratio of the rotational speed Nin of the shift input member 34 with respect to the rotational speed of the output member 36, and is calculated as a value obtained by dividing the rotational speed Nin of the shift input member 34 by the rotational speed of the output member 36. The output member 36 includes, for example, a shaft member (output shaft).

The output member 36 is drivingly coupled to the two right and left wheels W via a differential gear device 37. The torque transferred to the output member 36 is distributed and transferred to the two right and left wheels W via the differential gear device 37. The vehicle drive transmission device 3 can thus transfer the torque of one or both of the internal combustion engine EG and the rotary electric machine 33 to the wheels W to drive the vehicle.

The control device 1 serves as a main unit for controlling the operation of the components of the vehicle drive transmission device 3. As illustrated in FIG. 2, the control device 1 includes an integrated control unit 11, a rotary electric machine control unit 12, an engagement control unit 13, a state determination unit 14, and an in-shift slip control unit 15. These functional units are implemented by software (program) stored in a storage unit such as a memory, hardware such as a separately provided arithmetic circuit, or a combination of both. The functional units are configured to be capable of exchanging information with each other. Furthermore, the control device 1 is configured to be capable of acquiring information on the detection results of various sensors (a first sensor 51 to a third sensor 53) provided at different locations on the vehicle on which the vehicle drive transmission device 3 is mounted.

The first sensor 51 detects a rotational speed of the input member 31 and a member (for example, the internal combustion engine EG) that rotates with the input member 31. The second sensor 52 detects the rotational speed of the shift input member 34 and a member (for example, the rotary electric machine 33) that rotates with the shift input member 34. The third sensor 53 detects the rotational speed of the output member 36, or the rotational speed of a member (for example, the wheels W) that rotates synchronously with the output member 36. The term “synchronously rotate” refers to rotating at a rotational speed proportional to a reference rotational speed. The control device 1 can calculate the vehicle speed based on the detection result of the third sensor 53. Furthermore, the control device 1 can calculate the rotation acceleration (time rate of change in the rotational speed) of the input member 31, the shift input member 34, and the output member 36, by time-differentiating the detection results of the first sensor 51 to the third sensor 53, respectively. The control device 1 may be configured to be capable of acquiring information other than that described above, such as, for example, the accelerator operation amount, brake operation amount, and the amount of electricity stored in the electricity storage device.

The integrated control unit 11 performs control to integrate, over the entire vehicle, various types of control (such as torque control, rotational speed control, engagement control) that are performed on the internal combustion engine EG, the rotary electric machine 33, the decoupling engagement device 32, the speed change device 35 (shift engagement devices 35C), and so on. The integrated control unit 11 calculates the required vehicle torque that is required for driving the vehicle (wheels W), based on the sensor detection information (mainly, information on the accelerator operation amount and the vehicle speed).

The integrated control unit 11 determines the drive mode, based on the sensor detection information (mainly, information on the accelerator operation amount, the vehicle speed, and the amount of electricity stored in the electricity storage device). In the present embodiment, the travel mode that can be selected by the integrated control unit 11 includes an electric drive mode and a hybrid drive mode. The electric drive mode is a drive mode in which only the torque of the rotary electric machine 33 is transferred to the wheels W to drive the vehicle. The hybrid drive mode is a drive mode in which the torque of both the internal combustion engine EG and the rotary electric machine 33 is transferred to the wheels W to drive the vehicle.

The integrated control unit 11 determines the torque that the internal combustion engine EG is required to output (required internal combustion engine torque) and the torque that the rotary electric machine 33 is required to output (required rotary electric machine torque), based on the determined drive mode and the sensor detection information. The integrated control unit 11 determines the state of engagement of the decoupling engagement device 32, the target shift speed to be established by the speed change device 35, and so on, based on the determined drive mode and the sensor detection information.

In the present embodiment, the control device 1 (integrated control unit 11) controls the operating point (output torque and rotational speed) of the internal combustion engine EG, via an internal combustion engine control device 20. The internal combustion engine control device 20 can switch between torque control and rotational speed control of the internal combustion engine EG in accordance with the travel state of the vehicle. In the torque control of the internal combustion engine EG, a command for the target torque is provided to the internal combustion engine EG to make the output torque of the internal combustion engine EG follow the target torque. In the rotational speed control of the internal combustion engine EG, a command for the target rotational speed is provided to the internal combustion engine EG to determine the output torque such that the rotational speed of the internal combustion engine EG follows the target rotational speed.

The rotary electric machine control unit 12 controls the operating point (output torque and rotational speed) of the rotary electric machine 33. The rotary electric machine control unit 12 can switch between torque control and rotational speed control of the rotary electric machine 33 in accordance with the travel state of the vehicle. In the torque control of the rotary electric machine 33, a command for the target torque is provided to the rotary electric machine 33 to make the output torque of the rotary electric machine 33 follow the target torque. In the rotational speed control of the rotary electric machine 33, a command for the target rotational speed is provided to the rotary electric machine 33 to determine the output torque such that the rotational speed of the rotary electric machine 33 follows the target rotational speed.

The engagement control unit 13 controls the state of engagement of the decoupling engagement device 32, and the state of engagement of the plurality of shift engagement devices 35C included in the speed change device 35. In the present embodiment, the decoupling engagement device 32 and the plurality of shift engagement devices 35C are hydraulically-driven friction engagement devices. The engagement control unit 13 controls, via a hydraulic control device 41, the hydraulic pressure supplied to the decoupling engagement device 32 and each shift engagement device 35C, thereby controlling the state of engagement of the decoupling engagement device 32 and each shift engagement device 35C.

The engagement pressure of each engagement device changes in proportion to the magnitude of the hydraulic pressure supplied to the engagement device. Accordingly, the magnitude of the transfer torque capacity generated in each engagement device changes in proportion to the magnitude of the hydraulic pressure supplied to the engagement device. The state of engagement of each engagement device is controlled to be one of the direct-coupling engaged state, the slip engaged state, and the disengaged state, in accordance with the supplied pressure. The hydraulic control device 41 includes a hydraulic control valve (such as a linear solenoid valve) for adjusting the hydraulic pressure of the hydraulic oil supplied from an oil pump (not illustrated). Examples of the oil pump include, for example, a mechanical oil pump driven by the input member 31 or the shift input member 34, and an electric oil pump driven by a pump rotary electric machine. The hydraulic control device 41 regulates the opening of the hydraulic control valve in accordance with a hydraulic pressure command from the engagement control unit 13, thereby supplying hydraulic oil at a hydraulic pressure corresponding to the hydraulic pressure command to each engagement device.

The engagement control unit 13 controls the state of engagement of the decoupling engagement device 32 to establish the drive mode determined by the integrated control unit 11. For example, when establishing the electric drive mode, the engagement control unit 13 performs control to place the decoupling engagement device 32 in the disengaged state. When establishing the hybrid drive mode, the engagement control unit 13 performs control to bring the decoupling engagement device 32 into the direct-coupling engaged state.

Furthermore, the engagement control unit 13 controls the state of engagement of each of the plurality of shift engagement devices 35C to establish the target shift speed determined by the integrated control unit 11. The engagement control unit 13 performs control to bring two shift engagement devices 35C corresponding to the target shift speed into the direct-coupling engaged state, and performs control to bring all of the other shift engagement devices 35C into the disengaged state. Furthermore, in the case where the target shift speed is changed while the vehicle is traveling, the engagement control unit 13 performs control to switch specific shift engagement devices 35C from the direct-coupling engaged state to the disengaged state, and performs control to switch other specific shift engagement devices 35C from the disengaged state to the engaged state, based on the difference between the shift engagement devices 35C that need to be brought into the direct-coupling engaged state before the target shift speed is changed and those after the target shift speed is changed.

When a shift request for changing a speed ratio of the speed change device 35 is received while the internal combustion engine EG is operating with self-sustaining combustion, the state determination unit 14 determines whether the operational status of the internal combustion engine EG is changed to an inappropriate operating state during a shift operation that is performed in response to the shift request. The expression “the internal combustion engine EG operates with self-sustaining combustion” means that the internal combustion engine EG burns an air-fuel mixture in a cylinder, outputs torque greater than or equal to a predetermined magnitude at a rotational speed higher than or equal to an idle rotational speed Nid, and operates continuously without stopping. The shift request for changing the speed ratio of the speed change device 35 is made, for example, by changing the shift speed (target shift speed) to be established by the speed change device 35 in accordance with the vehicle speed and the required vehicle torque.

As a shift operation proceeds in response to the shift request, a rotational speed Nin of the shift input member 34, which is determined in accordance with (more specifically, in proportion to) the rotational speed of the wheels W and the rotational speed of the output member 36, is changed by the shift operation. For example, in the case of an upshift for switching from a shift speed with a relatively high speed ratio to a shift speed with a relatively low speed ratio, the rotational speed Nin of the shift input member 34 is significantly reduced by the upshift. Furthermore, for example, in the case of a downshift for switching from a shift speed with a relatively low speed ratio to a shift speed with a relatively high speed ratio, the rotational speed Nin of the shift input member 34 is significantly increased by the downshift. If it is assumed that, during the shift operation, the decoupling engagement device 32 is maintained in the direct-coupling engaged state, then the input member 31, which rotates with the internal combustion engine EG, rotates with the shift input member 34, and hence the rotational speed of the internal combustion engine EG is significantly changed by the shift operation. In the present embodiment, the rotational speed Nin of the shift input member 34 matches the rotational speed of the internal combustion engine EG that is determined in accordance with the rotational speed of the wheels W that is obtained when the decoupling engagement device 32 is brought into the direct-coupling engaged state.

Furthermore, in order to promote a change in the rotational speed Nin of the shift input member 34 and thereby to make the shift operation proceed, the torque to be transferred to the shift input member 34 may be changed. For example, in the case of an upshift, to promote a reduction in the rotational speed Nin of the shift input member 34, at least one of output torque Te of the internal combustion engine EG and the output torque of the rotary electric machine 33 may be reduced. Meanwhile, for example, in the case of a downshift, to promote an increase in the rotational speed Nin of the shift input member 34, at least one of the output torque Te of the internal combustion engine EG and the output torque of the rotary electric machine 33 may be increased.

In this way, as the shift operation proceeds, the rotational speed Nin of the shift input member 34 is changed, and the output torque Te of the internal combustion engine EG may be changed by the shift operation. That is, if it is assumed that the decoupling engagement device 32 is brought into the direct-coupling engaged state during a shift operation, an operating point P of the internal combustion engine EG that is determined in accordance with the rotational speed Neg and the output torque Te of the internal combustion engine EG is moved by the shift operation. Meanwhile, as illustrated in FIG. 3, for example, in a two-dimensional map with two axes representing the rotational speed Neg and the output torque Te of the internal combustion engine EG, there is an undesirable operating point area (or an operating point area to be avoided) indicated by hatching. In the present embodiment, this area is referred to as an “inappropriate operating area” in which the operational status of the internal combustion engine EG is an inappropriate operating state that results in preventing safe travel or comfortable travel of a vehicle.

As illustrated in FIG. 3, the inappropriate operating area includes at least a stall occurrence area S in which the rotational speed Neg is less than the idle rotational speed Nid. If the operating point P of the internal combustion engine EG moves into the stall occurrence area S, the rotational speed Neg and the output torque Te thereof gradually decrease, and eventually the internal combustion engine EG stops. When such a stall of the internal combustion engine EG occurs, the required vehicle torque is not fully achieved, which results in failing to maintain stable vehicle travel, and significantly reducing the traveling performance of the vehicle. Furthermore, in the present embodiment, the inappropriate operating area further includes a booming noise generation area M which is set to an area where the rotational speed Neg is mostly slightly higher than the idle rotational speed Nid, and the output torque Te is in the range of middle to high torque. When the operating point P of the internal combustion engine EG is in the booming noise generation area M, torque fluctuation due to periodic cylinder ignition or a reciprocating motion of the piston is amplified by a resonance phenomenon with a vibration system of the vehicle (for example, a suspension system, an exhaust pipe system, and a vehicle body system), so that vibration or booming noise is generated in the vehicle. Especially, in the case where the internal combustion engine EG has a small engine size (for example, 1,800 cc or less) or has a small number of cylinders (for example, four cylinders or less), vibration or booming noise is likely to be generated. Therefore, the comfort (traveling comfort) of the occupants during travel of the vehicle is reduced. In the present embodiment, such “traveling comfort” is included in the “traveling performance”.

As described above, since the vehicle drive transmission device 3 of the present embodiment is not provided with a hydraulic coupling, it is not possible to transmit the driving force of the internal combustion engine EG toward the wheels W unless the decoupling engagement device 32 is brought into the direct-coupling engaged state or the slip engaged state. Accordingly, in order to transmit the driving force of the internal combustion engine EG to the wheels W even during a shift operation, the decoupling engagement device 32 needs to be brought into the direct-coupling engaged state or the slip engaged state. If the decoupling engagement device 32 is in the direct-coupling engaged state, the rotational speed of the internal combustion engine EG matches the rotational speed Nin of the shift input member 34 that is determined in proportion to the rotational speed of the wheels W and the output member 36. In the case where an upshift is performed as a shift operation, the rotational speed Nin of the shift input member 34 is significantly reduced by the upshift. Thus, the operating point P of the internal combustion engine EG may move into the inappropriate operating area (the stall occurrence area S or the booming noise generation area M) located in the low rotational speed range as illustrated in FIG. 3. According to the structure of the present embodiment, in order to avoid this, in-shift slip control described below is executed to prevent the operating point P of the internal combustion engine EG from moving into the inappropriate operating area.

When a shift request is received, the state determination unit 14 determines, before changing the rotational speed Nin of the shift input member 34, whether the operating point P of the internal combustion engine EG will belong to the inappropriate operating area after shifting if the decoupling engagement device 32 is maintained in the direct-coupling engaged state. For example, at the time point when a shift request is received, the state determination unit 14 starts to determine whether the operating point P of the internal combustion engine EG will belong to the inappropriate operating area after shifting.

The state determination unit 14 estimates the rotational speed Nin of the shift input member 34 after shifting, based on a rotational speed Nout of the output member 36 at that point, a rotational acceleration A of the output member 36 at that point, a predetermined target shift time Tt, and a speed ratio λa after shifting. The state determination unit 14 estimates the rotational speed Nin of the shift input member 34 after shifting, based on (rotational speed Nin)={(rotational speed Nout)+(rotational acceleration A)·(target shift time Tt)} ·(speed ratio λa). Furthermore, the state determination unit 14 acquires information on target torque that is output from the internal combustion engine control device 20 to the internal combustion engine EG during a shift operation, and estimates the output torque Te of the internal combustion engine EG after shifting. The state determination unit 14 estimates the operating point P of the internal combustion engine EG after shifting in the case where the decoupling engagement device 32 is maintained in the direct-coupling engaged state, based on the estimated value of the rotational speed Nin of the shift input member 34 after shifting, and the estimated value of the output torque Te of the internal combustion engine EG after shifting. The state determination unit 14 then determines whether the estimated value of the operating point P of the internal combustion engine EG belongs to the inappropriate operating area.

In this step, the state determination unit 14 also determines to which of the stall occurrence area S and the booming noise generation area M the estimated value of the operating point P of the internal combustion engine EG belongs. In the example of FIG. 3, since the stall occurrence area S and the booming noise generation area M overlap partially, the estimated value of the operating point P of the internal combustion engine EG may belong to both the stall occurrence area S and the booming noise generation area M. In this case, the state determination unit 14 gives priority to belonging to the stall occurrence area S, and determines the estimated value of the operating point P of the internal combustion engine EG belongs to the stall occurrence area S.

When a determination is made that the operating point P of the internal combustion engine EG will belong to the inappropriate operating area after shifting if the decoupling engagement device 32 is maintained in the direct-coupling engaged state, the in-shift slip control unit 15 executes in-shift slip control to cause the decoupling engagement device 32 to slip during a shift operation. The in-shift slip control unit 15 reduces the engagement pressure of the decoupling engagement device 32 from a full engagement pressure to a slip engagement pressure lower than a direct-coupling limit engagement pressure, via the engagement control unit 13, thereby bringing the decoupling engagement device 32 into the slip engaged state. Note that the full engagement pressure is the maximum engagement pressure that is set to maintain the direct-coupling engaged state even if the torque transferred to the decoupling engagement device 32 varies. The direct-coupling limit engagement pressure is an engagement pressure at which the decoupling engagement device 32 in the direct-coupling engaged state starts to slip.

During execution of in-shift slip control, the in-shift slip control unit 15 controls the slip state of the decoupling engagement device 32 in different manners depending on which fact is the basis for determination of execution of the in-shift slip control. In the present embodiment, in the case where in-shift slip control is executed based on the fact that the estimated value of the operating point P of the internal combustion engine EG belongs to the stall occurrence area S (in other words, the estimated value of the rotational speed Nin of the shift input member 34 becomes less than the idle rotational speed Nid during a shift operation), the in-shift slip control unit 15 maintains the rotational speed Neg of the internal combustion engine EG at the idle rotational speed Nid or higher, during execution of the in-shift slip control. For example, the in-shift slip control unit 15 executes rotational speed control of the internal combustion engine EG using the idle rotational speed Nid as the target rotational speed, via the internal combustion engine control device 20, thereby maintaining the rotational speed Neg of the internal combustion engine EG at the idle rotational speed Nid. Thus, it is possible to minimize a rotational speed difference ΔW between paired engagement members included in the decoupling engagement device 32, and to prevent the internal combustion engine from stalling. Furthermore, by minimizing the rotational speed difference ΔW between the paired engagement members, it is possible to minimize heat generated by the decoupling engagement device 32, and to suppress thermal degradation of the decoupling engagement device 32.

Meanwhile, in the case where in-shift slip control is executed based on the fact that the estimated value of the operating point P of the internal combustion engine EG belongs to the booming noise generation area M, the in-shift slip control unit 15 only needs to cause at least the decoupling engagement device 32 to slip, during execution of the in-shift slip control. By causing the decoupling engagement device 32 to slip, the inertia system of the internal combustion engine EG can be separated from the inertia system of the wheel W side. This makes it possible to vary the resonance frequency, with respect to a state in which the decoupling engagement device 32 is maintained in the direct-coupling engaged state to form an integrated inertia system extending from the internal combustion engine EG to the wheels W. Accordingly, it is possible to prevent the torque fluctuation of the internal combustion engine EG from resonating with the vibration system of the vehicle side, and to reduce vibration and booming noise generated in the vehicle. Consequently, the travelling comfort can be well maintained.

During execution of in-shift slip control based on the relationship between the estimated value of the operating point P of the internal combustion engine EG and the booming noise generation area M, the in-shift slip control unit 15 preferably executes rotational speed control of the decoupling engagement device 32, via the engagement control unit 13. For example, the in-shift slip control unit 15 preferably executes rotational speed control in which the target value of the rotational speed difference ΔW between the paired engagement members included in the decoupling engagement device 32 is set to a predetermined slip differential rotation ΔWs. The slip differential rotation ΔWs is preferably appropriately set to a constant value in a range of, for example, 50 to 200 (rpm). In this case, the rotational speed difference ΔW between the paired engagement members included in the decoupling engagement device 32 is maintained constant, and the rotational speed Neg of the internal combustion engine EG is maintained higher than the rotational speed Nin of the shift input member 34 by the slip differential rotation ΔWs during execution of the in-shift slip control. Thus, it is possible to reliably maintain the slip engaged state of the decoupling engagement device 32 by performing relatively simple control, and to effectively suppress vibration and booming noise generated in the vehicle. In this case, the slip differential rotation ΔWs is preferably minimized within a range in which the slip engaged state of the decoupling engagement device 32 can be maintained. That is, rotational speed control of the decoupling engagement device 32 is preferably executed to have the minimum rotational speed difference with which the slip engaged state of the decoupling engagement device 32 can be stably maintained. This makes it possible to minimize heat generated by the decoupling engagement device 32, and to suppress thermal degradation of the decoupling engagement device 32.

In the case where the estimated value of the operating point P of the internal combustion engine EG belongs to the stall occurrence area S or the booming noise generation area M, the inertia system of the internal combustion engine EG can be separated from the inertia system of the shift input member 34, by executing in-shift slip control. Accordingly, due to the decoupled inertia system of the internal combustion engine EG, the inertia torque for changing the rotational speed Nin of the shift input member 34 at the time of completion of switching between shift speeds can be reduced. Accordingly, it is possible to reduce the torque difference generated upon completion of the shift operation, and hence to have a secondary effect of reducing the shock at the end of shifting.

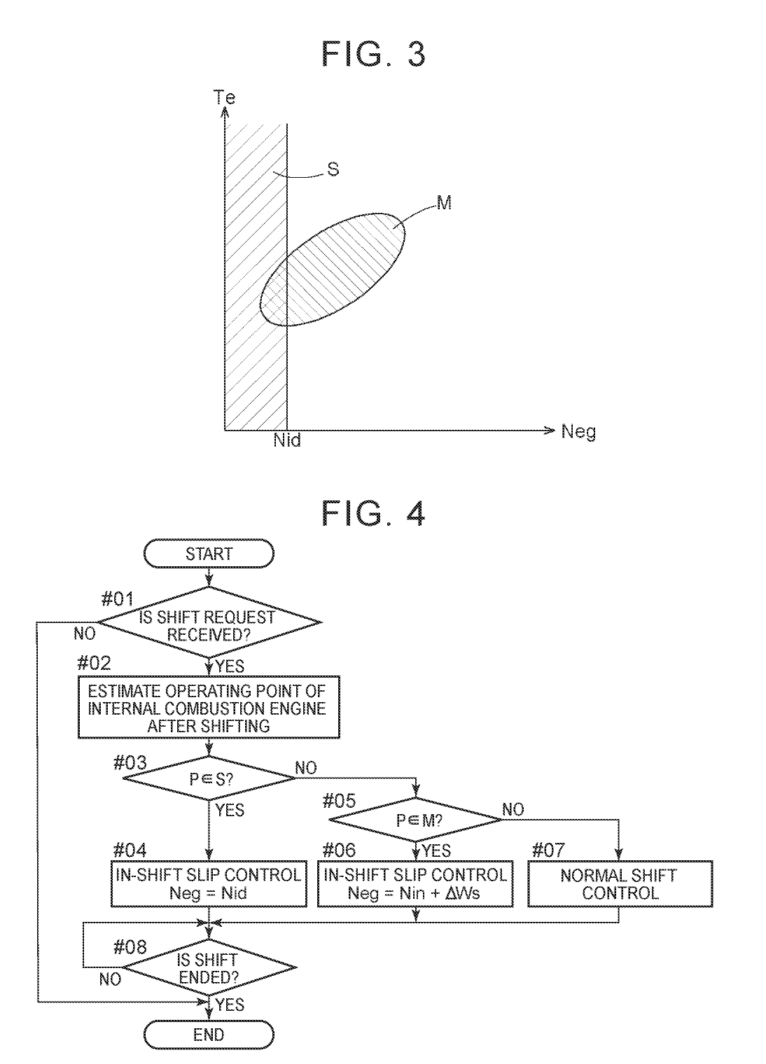

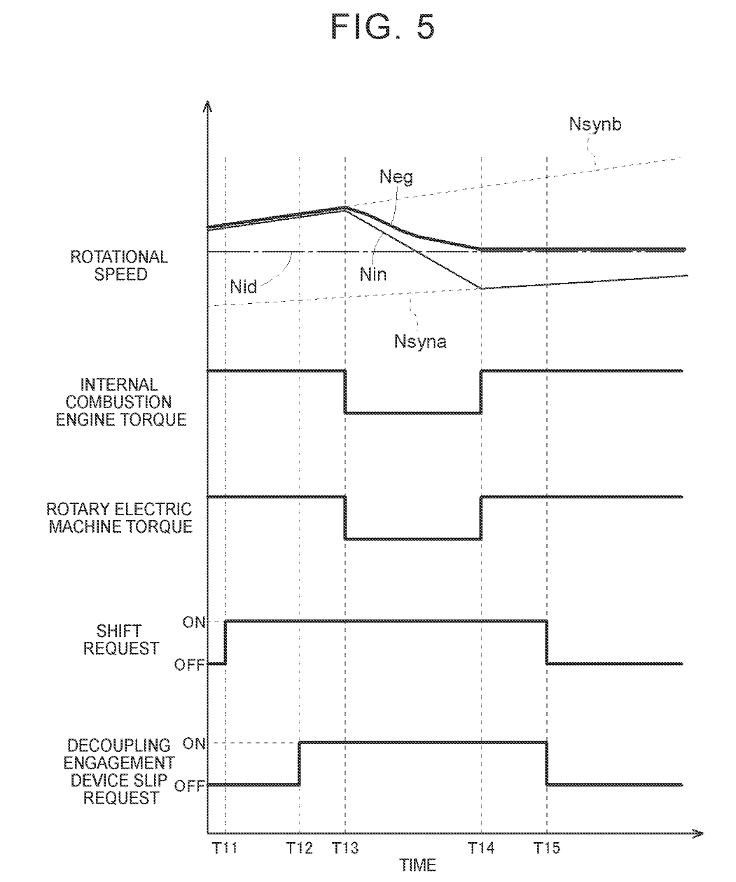

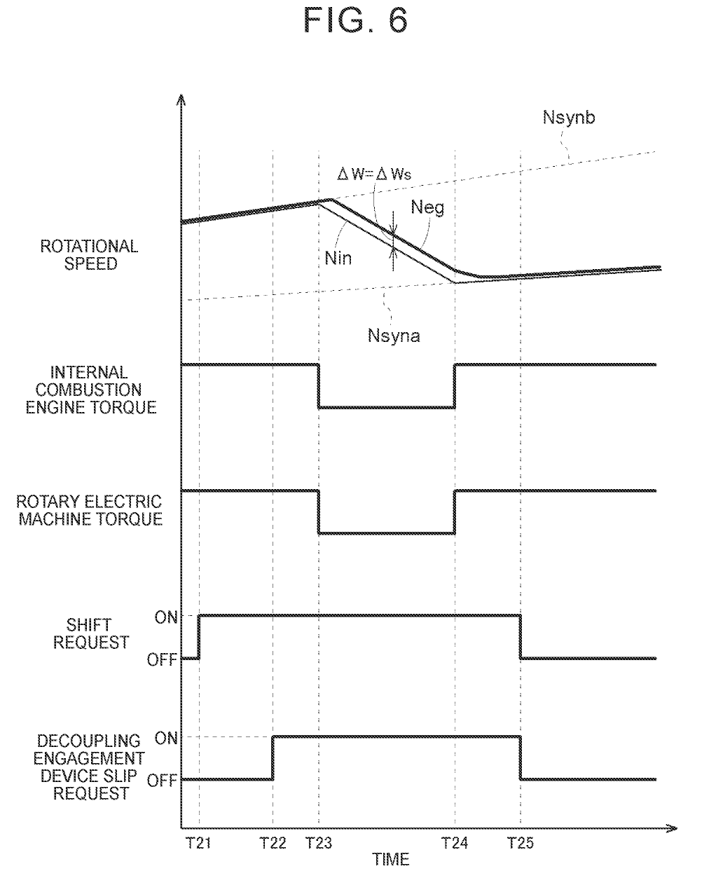

The following describes, with reference to FIGS. 4 to 6, a specific example of shift control including in-shift slip control that is executed mainly by the state determination unit 14 and the in-shift slip control unit 15. In the following example, the initial state for performing shift control is a state in which the decoupling engagement device 32 is in the direct-coupling engaged state while the internal combustion engine EG is operating with self-sustaining combustion, and the vehicle is driven in a hybrid drive mode. FIG. 5 illustrates an example of the case where in-shift slip control is executed based on the relationship between the estimated value of the operating point P of the internal combustion engine EG and the stall occurrence area S. FIG. 6 illustrates an example of the case where in-shift slip control is executed based on the relationship between the estimated value of the operating point P of the internal combustion engine EG and the booming noise generation area M. In FIGS. 5 and 6, a pre-shift synchronous rotational speed Nsynb calculated by multiplying the rotational speed of the output member 36 by the speed ratio λb before shifting and a post-shift synchronous rotational speed Nsyna calculated by multiplying the rotational speed of the output member 36 by the speed ratio λa after shifting are indicated by the thin broken lines.

First, when a shift request is received (step #01: Yes, time T11 in FIG. 5 and time T21 in FIG. 6), the operating point P of the internal combustion engine EG after completion of a shift operation is estimated based on the assumption that the decoupling engagement device 32 is maintained in the direct-coupling engaged state (#02). If the estimated value of the operating point P of the internal combustion engine EG belongs to the stall occurrence area S (#03: Yes), in-shift slip control starts (#04, T12 in FIG. 5). The in-shift slip control is continuously performed at least during the inertia phase (T12 to T14). In this example, the in-shift slip control is continuously performed until the shift operation is ended and the shift request is turned off (T12 to T15). During execution of the in-shift slip control, rotational speed control of the internal combustion engine EG is executed, so that the rotational speed Neg of the internal combustion engine EG is maintained at the idle rotational speed Nid.

Meanwhile, even when the estimated value of the operating point P of the internal combustion engine EG after completion of a shift operation does not belong to the stall occurrence area S (#03: No), if the estimated value belongs to the booming noise generation area M (#05: Yes), in-shift slip control starts (#06, T22 in FIG. 6). The in-shift slip control is continuously performed at least during the inertia phase (T22 to T24). In this example, the in-shift slip control is continuously performed until the shift operation is ended and the shift request is turned off (T22 to T25). During execution of the in-shift slip control (in particular, during the inertia phase, in this example), rotational speed control of the decoupling engagement device 32 is executed, so that the rotational speed difference ΔW between the paired engagement members included in the decoupling engagement device 32 is maintained at the constant slip differential rotation ΔWs. Accordingly, the rotational speed Neg of the internal combustion engine EG is maintained higher by the slip differential rotation ΔWs than the rotational speed Nin of the shift input member 34 that is determined in accordance with the rotational speed of the wheels W. Note that after the end of the inertia phase in which the rotational speed Nin of the shift input member 34 reaches the post-shift synchronous rotational speed Nsyna, the rotational speed difference ΔW of the decoupling engagement device 32 is preferably set to decrease gradually.

In the present embodiment, if the estimated value of the operating point P of the internal combustion engine EG after completion of the shift operation does not belong to either the stall occurrence area S or the booming noise generation area M, normal shift control is executed without executing in-shift slip control (#07). In the normal shift control, a shift operation is performed while the decoupling engagement device 32 is maintained in the direct-coupling engaged state.

During execution of the in-shift slip control (#04, #06) and the normal shift control (#07), monitoring is performed to determine whether the shift operation is actually ended (#08). A determination that the shift operation is ended can be made based on, for example, the fact that a hydraulic command for the specific shift engagement device 35C (engagement-side engagement device) that is newly engaged to establish the shift speed after shifting is increased to a value corresponding to the full engagement pressure. If a determination is made that the shift operation is ended (#08: Yes), the shift control (including in-shift slip control and normal shift control) is ended.

Note that, after the shift control is ended, if the rotational speed Nin of the shift input member 34 at that point is less than the idle rotational speed Nid (T15 in FIG. 5), the decoupling engagement device 32 continues to be maintained in the slip engaged state. Slip drive control is executed to drive the vehicle while causing the decoupling engagement device 32 to slip. During execution of the slip drive control, the rotational speed Neg of the internal combustion engine EG is maintained at the idle rotational speed Nid. Eventually, the rotational speed Nin of the shift input member 34 reaches the idle rotational speed Nid as the vehicle speed increases. The decoupling engagement device 32 then is brought into the direct-coupling engaged state, and the slip drive control is ended.

### OTHER EMBODIMENTS

(1) In the above embodiment, an example has been described in which during execution of in-shift slip control based on the relationship between the estimated value of the operating point P of the internal combustion engine EG and the stall occurrence area S, the rotational speed Neg of the internal combustion engine EG is maintained at the idle rotational speed Nid. However, the present disclosure is not limited thereto. For example, to allow some margin, the rotational speed Neg of the internal combustion engine EG may be maintained at a rotational speed for a stable self-sustaining combustion operation that is higher than the idle rotational speed Nid.

(2) In the above embodiment, an example has been described in which in-shift slip control is executed when the estimated value of the operating point P of the internal combustion engine EG belongs to the booming noise generation area M although the estimated value of the rotational speed Nin of the shift input member 34 does not become less than the idle rotational speed Nid during a shift operation. However, the present disclosure is not limited thereto. For example, in the case where a shift operation is performed on a low gear speed side, in-shift slip control may be executed although the estimated value of the rotational speed Nin of the shift input member 34 does not become less than the idle rotational speed Nid during the shift operation. The term “shift operation on a low gear speed side” refers to a shift operation between shift speeds each having a speed ratio greater than a predetermined reference speed ratio. With this configuration, it is possible to effectively reduce the risk of a shift end shock that is more likely to occur in the case of a shift operation on a low gear speed side.

(3) Alternatively, in-shift slip control may be executed regardless of whether other conditions are satisfied, even when the estimated value of the rotational speed Nin of the shift input member 34 does not become less than the idle rotational speed Nid during a shift operation. With this configuration, it is possible to at least reduce the shift end shock.

(4) Alternatively, on the contrary to the above, when the estimated value of the rotational speed Nin of the shift input member 34 does not become less than the idle rotational speed Nid during a shift operation, no in-shift slip control may be executed regardless of whether other conditions are satisfied. With this configuration, it is possible to easily prevent the internal combustion engine EG from stalling by performing relatively simple control.

(5) In the above embodiment, an example has been described in which during execution of in-shift slip control based on the relationship between the estimated value of the operating point P of the internal combustion engine EG and the booming noise generation area M, the rotational speed difference ΔW between the paired engagement members of the decoupling engagement device 32 is maintained constant. However, the present disclosure is not limited thereto, and the rotational speed difference ΔW between the paired engagement members may be changed, during execution of in-shift slip control. For example, in the inertia phase of a shift operation, the rotational speed difference ΔW may be gradually increased, and after the rotational speed Nin of the shift input member 34 reaches the post-shift synchronous rotational speed Nsyna, the rotational speed difference ΔW may be gradually reduced.

(6) In the above embodiment, a description has been mainly given of the case where the initial state for performing shift control is a state in which the vehicle is driven while the decoupling engagement device 32 is in the direct-coupling engaged state. However, the present disclosure is not limited thereto. For example, the initial state for performing shift control may be a state in which the vehicle is driven while the decoupling engagement device 32 is in the slip engaged state (slip drive control is performed). In this case, if a determination is made that the estimated value of the operating point P of the internal combustion engine EG belongs to the inappropriate operating area, a shift operation may be preferably started while the decoupling engagement device 32 is slipping (that is, without temporarily bringing the decoupling engagement device 32 into the direct-coupling engaged state).

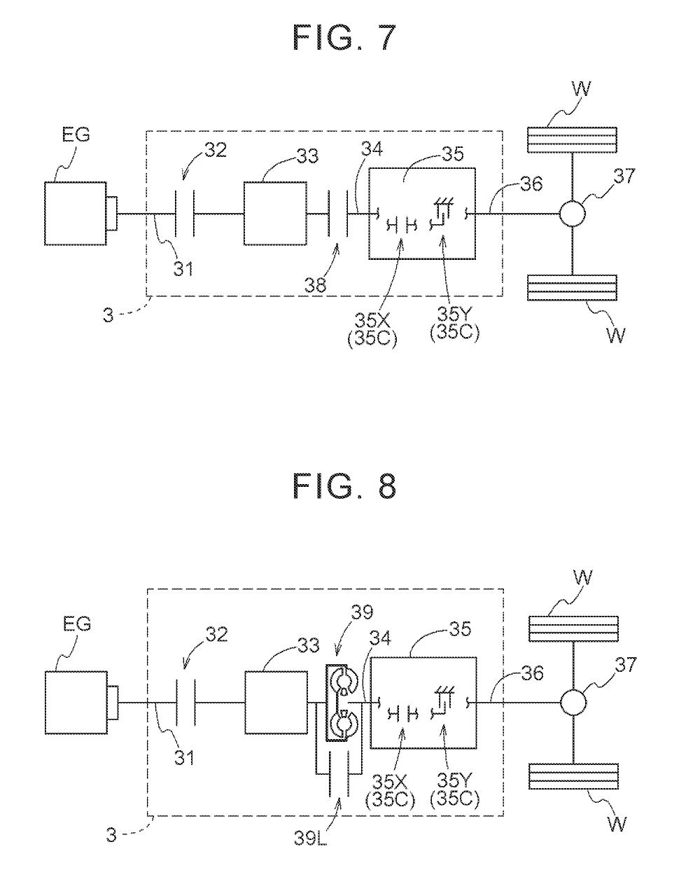

(7) In the above embodiment, an example has been described in which control is performed on the vehicle drive transmission device 3 including only the decoupling engagement device 32 as an engagement device provided on the power transmission path connecting the internal combustion engine EG and the wheels W. However, the present disclosure is not limited thereto. For example, as illustrated in FIG. 7, in the vehicle drive transmission device 3 that is controlled, a second decoupling engagement device 38 may be further provided on the power transmission path connecting the internal combustion engine EG and the speed change device 35. Alternatively, as illustrated in FIG. 8, a hydraulic coupling 39 (such as a torque converter and a fluid coupling) including a direct-coupling engagement device 39L may be further provided on the power transmission path connecting the internal combustion engine EG and the speed change device 35. In these cases, the “engagement device” that is caused to slip during a shift operation may be the decoupling engagement device 32, or may be the second decoupling engagement device 38 or the direct-coupling engagement device 39L.

(8) In the above embodiment, an example has been described in which the target shift speed is established when two of the plurality of shift engagement devices 35C are in the direct-coupling engaged state. However, the present disclosure is not limited thereto. For example, the target shift speed may be established when one or three or more shift engagement devices 35C are in the direct-coupling engaged state.

(9) In the above embodiment, an example has been described in which control is performed on the vehicle drive transmission device 3 including, as the speed change device 35, a type of stepped automatic speed change device that includes the planetary gear mechanism and the plurality of shift engagement devices 35C. However, the present disclosure is not limited thereto. In the vehicle drive transmission device 3 that is controlled, for example, another type of stepped automatic speed change device such as a dual clutch transmission (DCT) may be used as the speed change device 35.

The features disclosed in each of the above embodiments (including the embodiment and the other embodiments described above; the same applies to the following description) may be applied in combination with the features disclosed in the other embodiments as long as no inconsistency arises.

Regarding other features as well, it should be understood that the embodiments disclosed herein are merely examples in all respects. Accordingly, those skilled in the art may make various modifications without departing from the scope and spirit of the present disclosure.

### Summary of Embodiments

To summarize the above, a control device according to the present disclosure is preferably configured as described below.

[1]

A control device (1) that controls a vehicle drive transmission device (3) including a speed change device (35) disposed on a power transmission path connecting an internal combustion engine (EG) and wheels (W), and an engagement device (32, 38, 39L) disposed between the internal combustion engine (EG) and the speed change device (35), in which when a shift request for changing a speed ratio of the speed change device (35) is received while the internal combustion engine (EG) is operating with self-sustaining combustion, if a rotational speed (Neg) of the internal combustion engine (EG) becomes less than an idle rotational speed (Nid) during a shift operation that is performed in response to the shift request, the rotational speed (Neg) of the internal combustion engine (EG) being determined in accordance with a rotational speed of the wheels (W) that is obtained when the engagement device (32, 38, 39L) is in a direct-coupling engaged state, in-shift slip control is executed to cause the engagement device (32, 38, 39L) to slip during the shift operation such that the rotational speed (Neg) of the internal combustion engine (EG) is maintained at the idle rotational speed (Nid) or higher.

With this configuration, in the case where the rotational speed of the internal combustion engine becomes less than the idle rotational speed during the shift operation if the engagement device is maintained in a direct-coupling engaged state or brought into a direct-coupling engaged state, in-shift slip control is executed. By executing such in-shift slip control, it is possible to maintain the rotational speed of the internal combustion engine at the idle rotational speed or higher while transferring the output torque of the internal combustion engine to the transmission side. Thus, it is possible to appropriately drive the vehicle using the output torque of the internal combustion engine, and to prevent the internal combustion engine from stalling. Accordingly, it is possible to make the internal combustion engine operate stably, and to maintain stable vehicle travel.

[2]

During execution of the in-shift slip control, the rotational speed (Neg) of the internal combustion engine (EG) is maintained at the idle rotational speed (Nid).

With this configuration, it is possible to minimize the rotational speed difference between paired engagement members included in the engagement device disposed between the internal combustion engine and the speed change device, while maintaining stable vehicle travel by preventing the internal combustion engine from stalling. Accordingly, it is possible to minimize heat generated by the engagement device disposed between the internal combustion engine and the speed change device, and to reduce thermal degradation of the engagement device.

[3]

Even when the rotational speed (Neg) of the internal combustion engine (EG) does not become less than the idle rotational speed (Nid) during the shift operation, the rotational speed (Neg) of the internal combustion engine (EG) being determined in accordance with the rotational speed of the wheels (W) that is obtained when the engagement device (32, 38, 39L) is in the direct-coupling engaged state, if an operating point (P) of the internal combustion engine (EG) moves into a predetermined booming noise area (M) during the shift operation, the operating point (P) of the internal combustion engine (EG) being determined in accordance with the rotational speed (Neg) and output torque (Te) of the internal combustion engine (EG), the in-shift slip control is executed.

With this configuration, if the operating point of the internal combustion engine moves into the booming noise area during the shift operation, the inertia system of the internal combustion engine can be separated from the inertia system of the wheel side, by causing the engagement device disposed between the internal combustion engine and the speed change device to slip. This makes it possible to vary the resonance frequency, with respect to a state in which the engagement device is maintained in the direct-coupling engaged state. Accordingly, it is possible to prevent the torque fluctuation of the internal combustion engine from resonating with the vibration system of the vehicle side, and to reduce vibration and booming noise generated in the vehicle. Accordingly, it is possible to maintain stable vehicle travel, and also to improve the traveling comfort of the vehicle.

[4]

During execution of the in-shift slip control based on a relationship between the operating point (P) of the internal combustion engine (EG) and the booming noise area (M), a rotational speed difference (ΔW) between paired engagement members included in the engagement device (32, 38, 39L) is maintained constant.

With this configuration, it is possible to reliably maintain the slip engaged state of the engagement device by performing relatively simple control, and to effectively reduce vibration and booming noise generated in the vehicle. Furthermore, by setting an appropriate target value for the rotational speed difference between the paired engagement members, it is possible to minimize heat generated by the engagement device disposed between the internal combustion engine and the speed change device, and to suppress thermal degradation of the engagement device.

[5]

It is particularly appropriate to execute the in-shift slip control when the shift operation is an upshift operation for switching from a shift speed with a relatively high speed ratio to a shift speed with a relatively low speed ratio.

As described above, in the case of performing upshift as a shift operation, the rotational speed of the internal combustion engine is significantly reduced by the upshift. Therefore, if the engagement device is maintained in the direct-coupling engaged state, the rotational speed of the internal combustion engine may become less than the idle rotational speed. Thus, by executing an in-shift slip control when performing such an upshift operation, the rotational speed of the internal combustion engine can be maintained at the idle rotational speed or higher.

The control device according to the present disclosure only needs to provide at least one of the above advantageous effects.

1. A control device that controls a vehicle drive transmission device including a speed change device disposed on a power transmission path connecting an internal combustion engine and wheels, and an engagement device disposed between the internal combustion engine and the speed change device, the control device comprising:
an electronic control unit that is configured to execute in-shift slip control to cause the engagement device to slip during a shift operation such that a rotational speed of the internal combustion engine is maintained at an idle rotational speed or higher, when a shift request for changing a speed ratio of the speed change device is received while the internal combustion engine is operating with self-sustaining combustion, if the rotational speed of the internal combustion engine becomes less than the idle rotational speed during the shift operation that is performed in response to the shift request,
wherein the rotational speed of the internal combustion engine is determined in accordance with a rotational speed of the wheels that is obtained when the engagement device is in a direct-coupling engaged state.

2. The control device according to claim 1, wherein
during execution of the in-shift slip control, the electronic control unit maintains the rotational speed of the internal combustion engine at the idle rotational speed.

3. The control device according to claim 1, wherein
the electronic control unit executes the in-shift slip control even when the rotational speed of the internal combustion engine does not become less than the idle rotational speed during the shift operation, if an operating point of the internal combustion engine moves into a predetermined booming noise area during the shift operation,
the rotational speed of the internal combustion engine is determined in accordance with the rotational speed of the wheels that is obtained when the engagement device is in the direct-coupling engaged state, and
the operating point of the internal combustion engine is determined in accordance with the rotational speed and output torque of the internal combustion engine.

4. The control device according to claim 3, wherein
during execution of the in-shift slip control based on a relationship between the operating point of the internal combustion engine and the booming noise area, the electronic control unit maintains a rotational speed difference between paired engagement members included in the engagement device constant.

5. The control device according to claim 1, wherein
the shift operation is an upshift operation for switching from a shift speed with a relatively high speed ratio to a shift speed with a relatively low speed ratio.
